(19) United States
(12) Patent Application Publication
(10) Pub. No.: US 2025/0315918 A1
(43) Pub. Date: Oct. 9, 2025

(54) SMART BOX SCALING

(71) Applicant: Fiery, LLC, Fremont, CA (US)

(72) Inventors: Patrick H. Wood, Lake Hopatcong, NJ (US); Sol Goldenberg, Rockaway, NJ (US)

(21) Appl. No.: 18/629,759

(22) Filed: Apr. 8, 2024

(51) Int. Cl. G06T 3/40; G06F 3/04845; G06T 5/77; G06T 11/20; G06V 20/70

(52) U.S. Cl. CPC G06T 3/40; G06F 3/04845; G06T 5/77; G06T 11/203; G06V 20/70

(57) ABSTRACT

Independent scaling of individual box panels allows one design to be used for multiple box sizes. Different graphic elements, e.g. bar codes, logos, etc. retain their aspect ratio even when the artwork for a panel must be stretched asymmetrically to fit a new size.

### FIELD

Various of the disclosed embodiments concern smart box scaling.

### BACKGROUND

Over the last few years, retailers with large shipping operations have built warehouses that ship thousands of boxes each day. Many of these boxes are printed, cut, and folded automatically and on demand as orders are picked, placed on conveyors, and packed for shipping. Custom artwork for these boxes is designed for various marketing reasons, e.g. advertising, product tie-ins, holiday promotions.

The artwork is printed on flat corrugated sheets that are cut, folded, and glued by robotic devices, and each box is a different size to match the corresponding product being shipped. Current automated cutting/folding machines can be preprogrammed with dozens of different box sizes and shapes, and future machines will be able to create an infinite number of sizes and shapes.

The current art involves creating some sort of 3D representation of the physical packaging and fitting text and images onto the sides, either automatically or via some sort of template to prevent graphical elements from overlapping.

Boxes come in many different shapes and sizes. A box design can have many graphical elements, including photos, logos, coupons, seasonal graphics (e.g. snowflakes, pumpkins, turkeys, etc.), shipping labels, bar codes, DOT labels (e.g. flammable, caustic, ground only), etc.

Currently, for any promotion, a designer must create a different layout for each supported box size. This is labor intensive and often limits the number of box sizes that are available, either requiring the shipper to use a larger box or skip the promotion for certain box sizes.

For example, the artwork for a box measuring 8×8×8 inches on a side, if scaled to a box 16×8×8 inches would have one side stretched larger while the other two remain the same size. Scaling the design along this one edge would distort some graphical elements in an unacceptable fashion, e.g. a company's logo becomes elongated or a shipping label is stretched beyond the dimensions required by the shipper.

State of the art automated methods do not allow for very complex or pleasing designs.

### SUMMARY

In embodiments of the invention, independent scaling of individual box panels allows one design to be used for multiple box sizes. Different graphical elements, e.g. bar codes, logos, etc. retain their aspect ratio even when the artwork for a panel must be stretched asymmetrically to fit a new size.

### BRIEF DESCRIPTION OF THE DRAWINGS

FIG. 1 is a plan view of an unfolded box;

FIG. 2 is a block diagram showing a smart box scaling system according to an embodiment of the invention;

FIG. 3 shows a printer controller with an embedded scaling engine according to an embodiment of the invention;

FIG. 4 is a flow diagram showing smart box scaling according to an embodiment of the invention;

FIG. 5 shows a design template according to an embodiment of the invention;

FIG. 6 shows the selection of a graphical element in the smart scaling app and different scaling attributes that can be assigned to it according to an embodiment of the invention;

FIGS. 7 and 8 show previews of scaled boxes according to an embodiment of the invention;

FIG. 9 shows 4 boxes having a background image or file large enough to cover the area of the maximum box size;

FIG. 10 shows an image of a scaled box instance that is used as a preview of the final box;

FIG. 11 shows an image of a scaled box instance that is used as a preview of the final box of FIG. 10 in which panels that should be blanked are shown; and

FIG. 12 is a block diagram of a computer system as may be used to implement certain features of some of the embodiments.

### DETAILED DESCRIPTION

Embodiments of the invention allow a graphic designer to create a single design that can be appropriately scaled for a variety of box sizes and shapes.

### Glossary

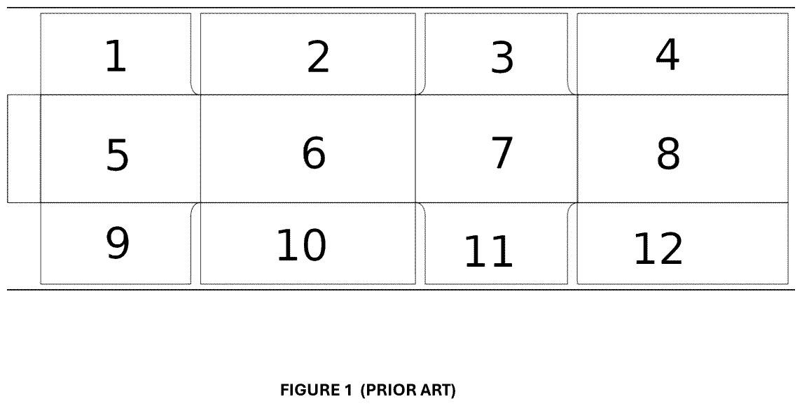

Panel: One face of a box.
Flap: Wider flaps (faces #2, 4, 10, and 12 in FIG. 1) are half faces that when folded together form a top or bottom panel and are visible on the outside of the box; narrower flaps (faces #1, 3, 9, and 11 in FIG. 1) are folded under and typically not printed on.
Glue flap: Small, foldable strip to which glue is applied to hold the box together when assembled (the narrow, unnumbered flap at the very left in FIG. 1).
Design template/file: Outlines drawn in custom colors that describe the layout of the box panels, flaps, and optionally graphic elements that require special handling, and the file it is saved to.
Master box design/file: PDL artwork for a box drawn on top of the template and the file it is saved to.
Final box and final box file: The ready-to-print PDL for printing the box scaled to the requested dimensions and the file it is saved to.
Graphical element: Artwork, text, or image that comprise a box design.
Scaling attributes: Scaling and placement constraints placed on one or more graphical elements so they can scale independently of the panel they are on.
Rule: Combination of graphical element(s) and scaling attributes.
Control information: Rules, VDP information, and panel boundaries.
Smart scaling file: File combining the master design file, rules, and (optionally) configuration information.
Background image or PDL file: Box design background that is either not scaled at all or is only scaled to fit the entire sheet the box is printed on and not differently based on the width, height, or depth scaling of the box.
Variable data printing (VDP): Placing a different graphic element, e.g. shipping label, bar code, on every box without creating a new box design for each instance. Typically performed by replacing proxy or placeholder elements with an images or small PDL files.
Inpainting: Inpainting replaces or edits specific areas of an image. This makes it a useful tool for image restoration like removing defects and artifacts, or even replacing an image area with something entirely new. Inpainting relies on a mask to determine which regions of an image to fill in; the area to inpaint is represented by white pixels and the area to keep is represented by black pixels. The white pixels are filled in by the prompt.
Outpainting: Outpainting continues an image beyond its original borders, for example adding or expanding visual elements in the same style.

### DISCUSSION

FIG. 1 is a plan view of an unfolded box. A typical box or box has six faces: front, back, left side, right side, top and bottom. The front, back, and sides are called “panels” (5, 6, 7, and 8 in FIG. 1). The top and bottom of a box are split in half and fold over; these half faces are called “flaps.” The wider flaps (2, 4, 10, and 12 in FIG. 1) are on the outside of the box and anything printed on them is visible. The narrower flaps (1, 3, 9, and 11 in FIG. 1) are folded under the wider flaps and are typically not printed on.

In some embodiments of the invention only the flaps on the bottom of the box are glued when the box is assembled by automated machinery. As such, in these embodiments, something can be printed on flaps 1 and 3, but these flaps are only visible when the box is opened.

A small flap by itself in the leftmost part of the box, for purposes of the discussion herein is referred to as the “glue flap” because it is glued to the underside of panel 8. This flap is hidden once the box is assembled.

Typically, the pigments used for printing on corrugated boxes do not adhere as well to glues as to cardboard, so it is typically not possible to print on any surfaces being glued together. In embodiments of the invention, these are flaps 9, 11, and the glue flap. In some embodiments, the top flaps are taped after the product and packing materials are put in the assembled box.

Opposing panels on a box (5/7 and 6/8) are always the same dimensions. All the panels (5, 6, 7, and 8) and the glue flap must be the same height. The four wide outside flaps are the same dimensions, and the four narrow inside flaps are the same dimensions. All flaps in the top and bottom rows must also be the same height. Note that for proper folding, the inside flaps and the glue flap are often trimmed to a slightly smaller size by cutting machinery.

Boxes scale by width, height, and depth. The width affects the front and back panels as well as the outside flaps (2, 4, 6, 8, 10, and 12). The height affects all panels (5, 6, 7, and 8) and the glue flap, but not the other flaps. The depth affects the width of the side panels 5 and 7; it also affects the height of the flaps 1, 2, 3, 4, 8, 9, 10, 11, and 12 because the wide opposing flaps 2, 4, 10, and 12 must touch in the middle of panels 5 and 7 when folded over, and adjusting their height affects all flaps in the top and bottom rows.

Not all boxes are the same. Some are cubic while others are rectangular. Some are short and others tall. As a consequence, the proportions of the box panels and flaps vary independently. Designers must be aware that when the box shape changes, the graphical elements on them may scale, either larger or smaller, in unexpected ways, creating problems for the customer. For instance, if a box contains a square logo and is designed for a rectangular surface which is 16×8 inches, the logo is distorted if the same design is scaled to fit to a square 8×8 surface.

The herein disclosed solution to these design problems allows the designer to specify the graphical elements that require special consideration when the design is scaled to different sizes.

Another design goal is to minimize changes to the designer's current processes and workflows. The input and output is typically a page description language file, e.g., PDF or PostScript.

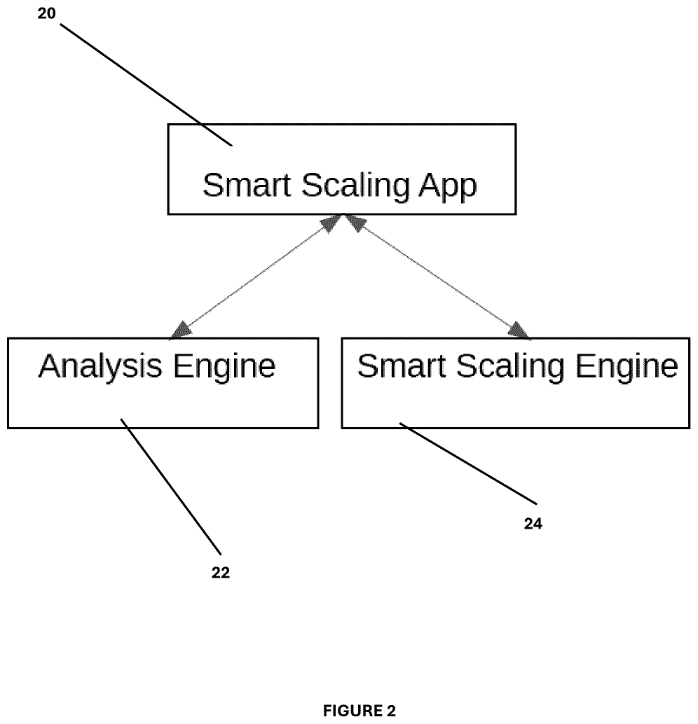

FIG. 2 is a block diagram showing a smart box scaling system. Embodiments of the invention comprise the following elements. Those skilled in the art will appreciate that these elements may comprise separate elements each of which can be associated with a different portion of the box design and print workflow or the elements may be joined in any combination as appropriate for the application in which they are deployed.

Smart Scaling App. The smart scaling app 20 includes the user interface (UI) and overall prepress control code. When the user selects a master box design file, the app sends the file to the analysis engine 22, which provides information about the location of all the graphical elements in the file and the location of the panels from the design template. After the user creates rules, when generating previews, proofs, or saving the smart scaling file, the smart scaling app passes the rules and previous analysis information to the analysis engine and receives information (see below) that it passes, along with one or more final box dimensions, to the smart scaling engine 24, which produces the final box PDL file(s), or which it saves in the smart scaling file.

Analysis Engine. The analysis engine 22 includes the logic to analyze the master box design file and supplies the smart scaling app with information about the location of all the graphical elements in the file as well as the location of the template rectangles describing the panels and graphical elements that may require special handling, such as print-time replacement. When scaling is required, or when saving the smart scaling file, the analysis engine divides the master design file into individual components comprising the panels, the annotated graphical elements, and all other graphical elements and saves it all in a smart scaling file or in separate files.

Smart Scaling Engine. The smart scaling engine 24 inputs the master box design file and control information, either from a single smart scaling file, from separate files, or from memory, along with the dimensions of the box(es). The smart scaling engine scales the panels and graphical elements that are not part of any rules based on the width/height/depth dimensions of the final box. It scales graphical elements contained in each rule by applying a combination of the final box dimensions and the constraints contained in the rule, for example limiting the scale factor applied based on the minimum or maximum width or height, maintaining a fixed or minimum distance from a panel's corner or edge, or scaling both the width and height of a graphical element by one value instead of two to maintain the element's aspect ratio.

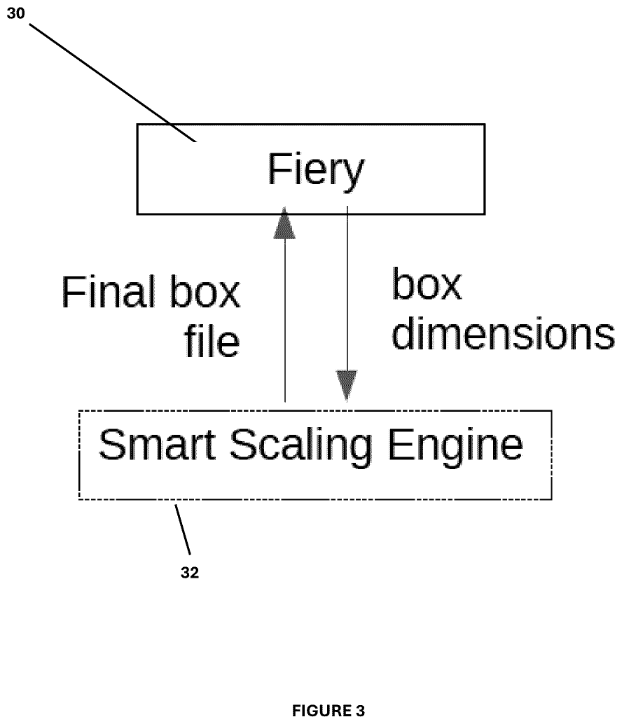

FIG. 3 shows a printer controller with an embedded scaling engine according to an embodiment of the invention. The scaling engine reads the smart scaling file, control information (which is optionally embedded in the smart scaling file), and box dimensions+VDP replacement files to print one or more boxes of different scales and/or with different VDP elements. The smart scaling file can be sent to a printer, such as a Fiery printer 30 (https://www.fiery.com/), for production-time scaling by a separate smart scaling engine 32, allowing printing of arbitrarily scaled boxes at facilities physically separate from where design occurs, e.g. a warehouse or third-party shipping fulfillment facility.

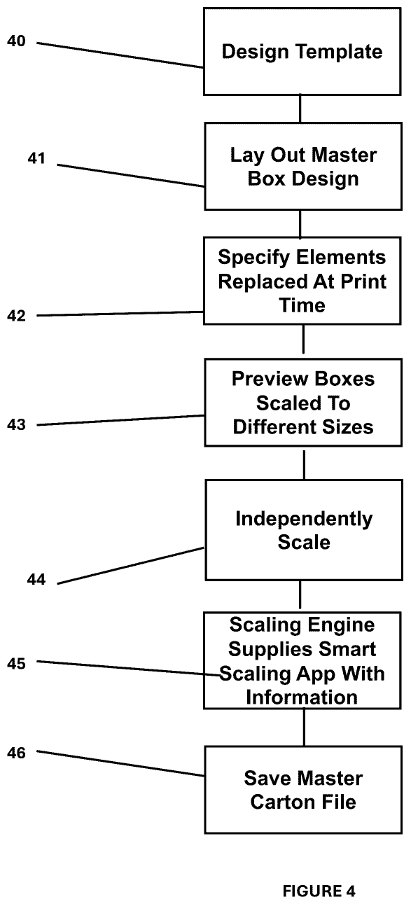

FIG. 4 is a flow diagram showing smart box scaling according to an embodiment of the invention.

The designer starts with a design template 40 which, in some embodiments of the invention can comprise a template file supplied by Fiery (https://www.fiery.com/) that contains rectangle outlines drawn in a spot color, such as a custom Fiery spot color or other spot color, that lays out the panel and flap elements described above, as well as any regions of the box design that may require special handling, such as print-time replacement.

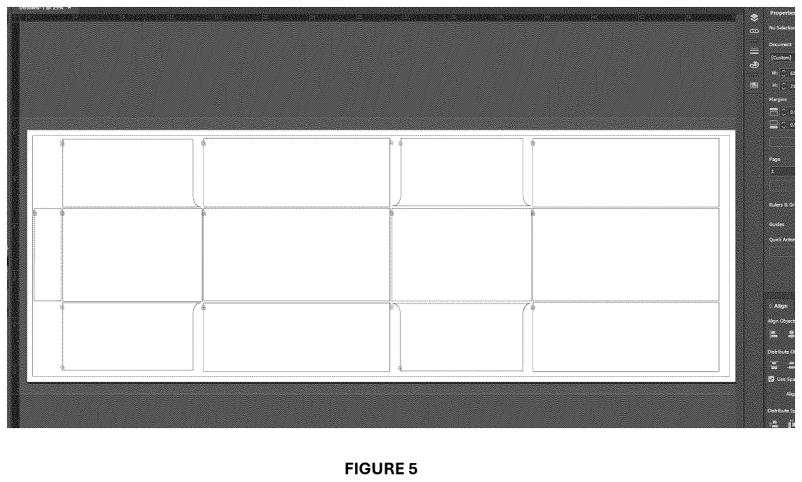

FIG. 5 shows a design template according to an embodiment of the invention. Embodiments of the invention supply an Adobe InDesign template, but those skilled in the art will appreciate that embodiments of the invention could be applied to other graphics design packages, such as Adobe Illustrator, QuarkXPress, etc. These embodiments of the invention find the rectangles drawn in the special spot colors and use them to determine the initial dimensions of the box and panels/flaps and to determine which panel(s)/flap(s) an annotated graphical element may reside on. Any colors can be used as spot colors except those colors that could be a pigment, e.g. Cyan, Magenta, Yellow, Black, Gray, Blue, Green, Orange, Pantone colors, metallic inks, and so on. While the spot colors are removed from the final box file for printing, they may be retained when previewing a scaled box on screen or when printing proof copies to allow designers to verify proper placement and scaling of graphical elements and panels. Those skilled in the art will appreciate that other methods could be used to mark the panel boundaries, e.g. the designer could start from a fixed layout, or the designer could draw the box panels directly into the design using unique colors or some other unique design feature that the system could detect automatically.

The spot colors are removed from the final box file for printing, but they may be retained when previewing a scaled box on screen or when printing proof copies to allow designers to verify proper placement and scaling of graphical elements and panels.

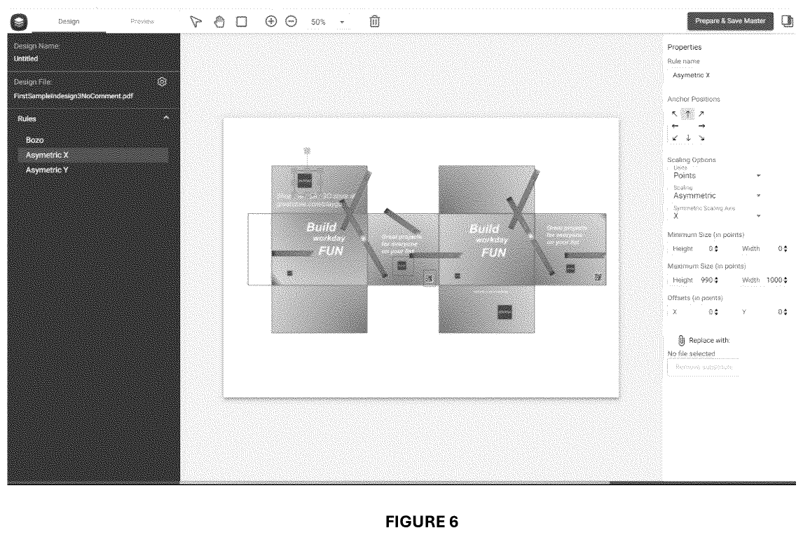

Returning to FIG. 4, the designer lays out the master box design in this template and exports it to the smart scaling app as a PDF or other format file 41. FIG. 6 shows the selection of a graphical element in the smart scaling app and different scaling attributes that can be assigned to it according to an embodiment of the invention. The smart scaling app allows the designer to create a rule by selecting different graphical elements on the box and annotating them with advanced scaling attributes. For example, logos and QR codes should maintain their aspect ratio even if the panel or flap they are on is not scaled symmetrically. Other graphical elements, such as shipping labels may need to remain the same size and shape regardless of box size and may require minimum offsets from a panel's side or corner to conform to marking requirements such as shipper or DOT requirements, QR codes, barcodes, and text may require a minimum size.

Scaling attributes applied to a graphical element may include, for example, any of the following:
Symmetric (equal horizontal and vertical), asymmetric, or no scaling;
For symmetric scaling, the side that the scaling is relative to;
Minimum and/or maximum width and/or height;
Fixed offset from a corner or side; and/or
Minimum offset from a corner or side.

Embodiments of the invention provide variable data printing (VDP) which places a different graphic element, e.g. shipping label, bar code, on every box without creating a new box design for each instance. VDP is typically performed by replacing proxy or placeholder elements with images or small PDL files. Returning to FIG. 4, the designer may specify graphical elements that are replaced at print time with something specific to that shipment 42, e.g. shipping address, tracking barcode, DOT labels, or a customer-targeted web site URL encoded in a QR code. These can be drawn, for example, with a custom Fiery spot color or other color in the master box design and flagged for replacement in the app for later substitution. They may also be drawn in the design template and locked in place with default scaling attributes so they are always in the same place, scale properly for multiple promotions, and cannot be repositioned or drawn over later by a designer.

In a different embodiment, these graphical elements could be added directly via annotations in the smart scaling app. Any graphical elements that are not annotated with special scaling attributes are scaled with the same ratios as the sides of the panels or flaps they are on.

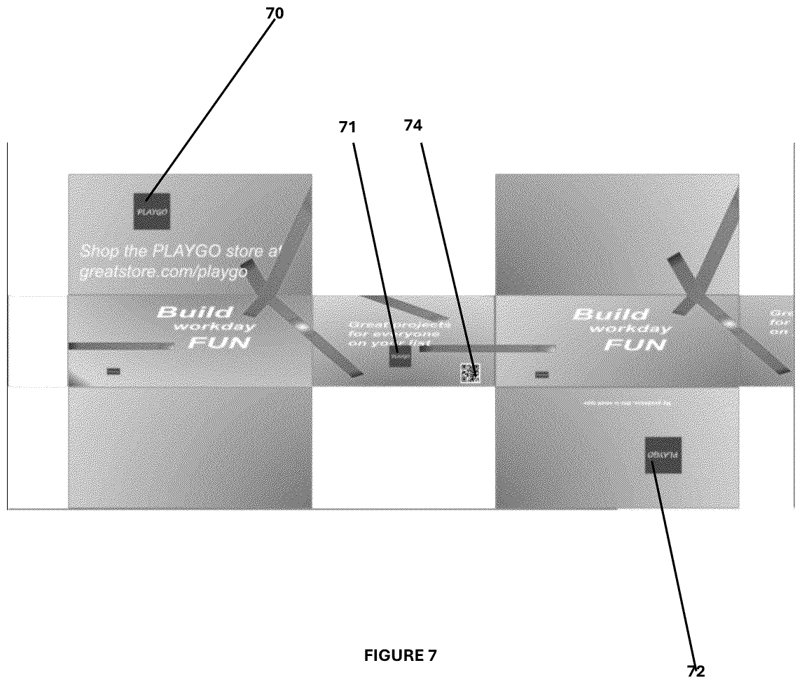

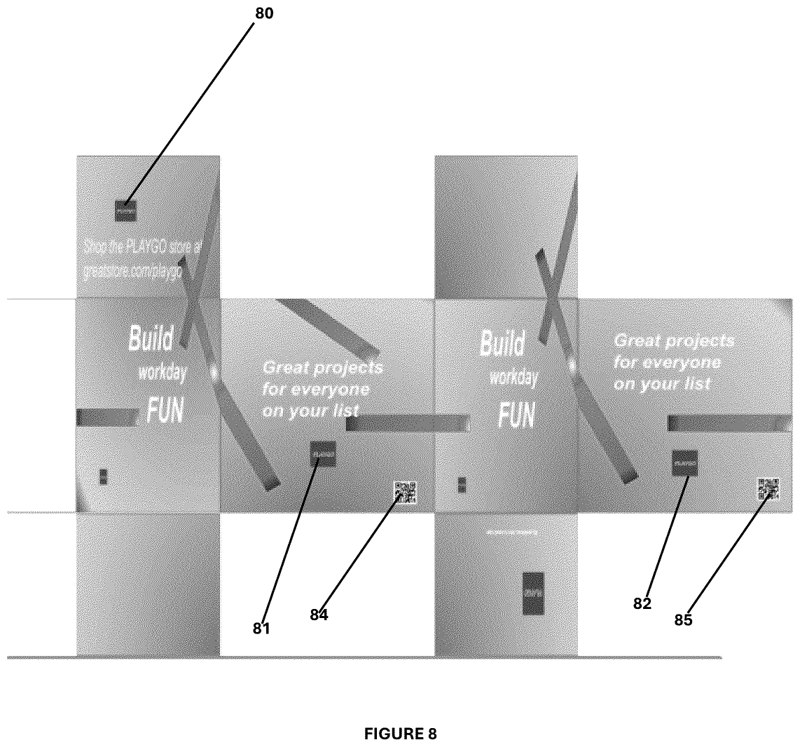

Once the designer has marked all graphical elements that require special scaling, he can preview boxes scaled to different sizes from the user interface 43. See FIGS. 7 and 8 which show previews of scaled boxes according to an embodiment of the invention in which a box design is stretched horizontally (FIG. 7) and stretched vertically (FIG. 8). Notice how the logos 70-72 (FIG. 7), 80-82 (FIG. 8) and QR codes 74 (FIG. 7), 84, 85 (FIG. 8) in panels 1, 7, and 8 remain square regardless of the relative width and height of the panels, while the logos on the other panels scale differently in the vertical and horizontal directions. Also note how the text and graphics scale relative to the panels' sides on all panels, independent of the logo and QR code scaling, and the graphics that cross panel boundaries meet up at the edges.

The designer may also print proofs of the scaled boxes at any time, either at a reduced size to fit on typical desktop printer paper or at 1:1 scale on a printer capable of printing sheets as large as a corrugated box sheet to create mockups of the boxes.

Returning to FIG. 4, embodiments of the invention allow the designer to scale 44 the height of each row of panels independently of the other rows and the width of a column of panels independently of the other columns, to scale individual objects independently of the panels and each other, and to control the positioning of individual objects independently of their scale.

While the designer is previewing different box sizes, the smart scaling engine supplies the smart scaling app with information 45 about any annotated graphical elements that exceed a panel/flap boundary or any annotated graphical elements that overlap by checking for intersections of the scaled bounding boxes of the annotated graphical elements and panels/flaps. These conditions can occur due to the different scaling that's applied to these graphical elements and the panels/flaps.

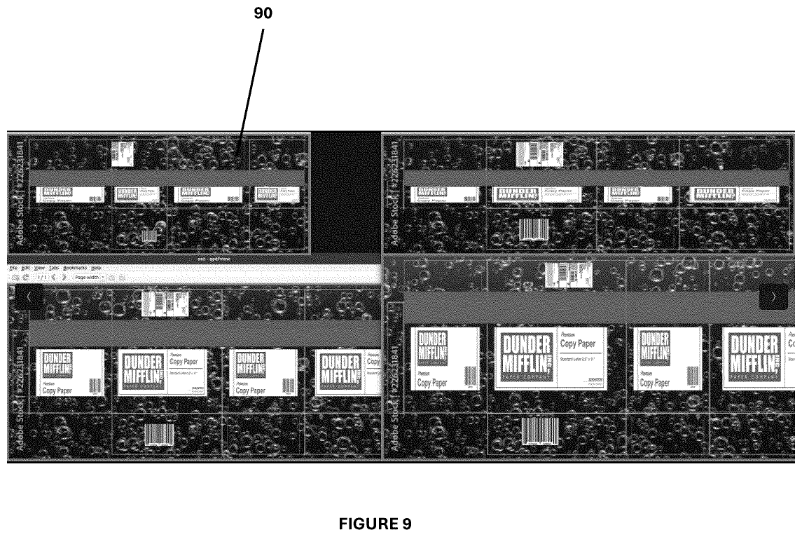

FIG. 9 shows 4 boxes having a background image or file large enough to cover the area of the maximum box size. In the embodiment of FIG. 9, the designer can select a background image 90 or file large enough to cover the area of the maximum box size. No scaling is applied to this background to prevent unsightly distortions due to large differences in scaling from the smallest to largest box. In another embodiment, a smaller image or file could be selected as the background and scaled up to fit the area of the current box being printed to prevent distortions.

Returning to FIG. 4, once satisfied with the box layout at different sizes, the user can save it in a smart scaling file 46. When either previewing, proofing, or saving the file, the application runs the analysis engine. The analysis engine uses the rules defined by the designer to determine which graphical elements fall within the boundaries of the rule. It uses this set of information to specially format a set of master instructions for the smart scaling engine, identifying the panels and/or flaps these graphical elements are on and the special scaling attributes assigned to the rule by the designer. The rules and graphical elements chosen by the designer, along with the panel boundaries determined from the design template (collectively called the “control information”), along with the dimensions of the box are passed directly to the smart scaling engine to immediately produce a final box file for preview or proofing, or to be saved for later use. The control information can be saved in its own file or as part of the smart scaling file and later used as input to the smart scaling engine for printing the physical box sheets.

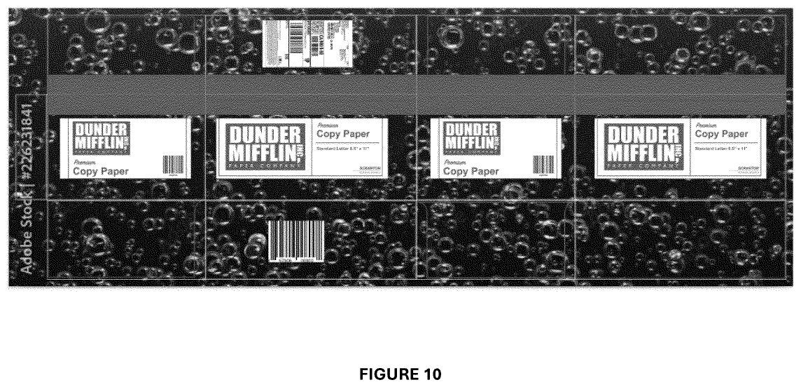

FIG. 10 shows an image of a scaled box instance that is used as a preview of the final box file. When a box is previewed, proofed, or printed the smart scaling engine reads the smart scaling file along with the physical dimensions of the input sheet from which the box is to be made and final dimensions of the panels/flaps. The smart scaling engine uses these along with the background and any files supplied for graphical element replacement and produces a scaled, ready-to-print PDF or other format file that is used to preview or print the final box. The smart scaling engine determines the scaling for each panel/flap side by applying the appropriate width, height, or depth scale depending on the panel's/flap's position in the box (see FIG. 1). It then determines the scaling for each annotated graphical element in a rule by applying both the enclosing panel's/flap's scaling adjusted by constraints based on the rule. For example, symmetric X/Y scaling requires the scaling engine to apply only one of the X or Y scaling of the panel/flap to both dimensions of the element, and limits on the minimum or maximum size or position relative to the panel/flap edges may force adjustments to the element's X/Y scaling and the location of the element to remain within those constraints. The design template may be left in the ready-to-print file or left out by user request. It is typically removed prior to printing the final box destined for folding and printing.

In some embodiments, the smart scaling engine can create multiple final box files of different dimensions and/or with different variable data for each box from the smart scaling file in a single invocation, allowing for high-speed box production.

In further embodiments, the scaling engine can produce a list of intersections for multiple box sizes. The scaling app can then use this list to present information about all of the available box sizes for the user to preview at the same time, instead of presenting box size information to the user for one box at a time.

Also, in some embodiments of the invention the smart scaling app calls the analysis engine for information about the PDF file when it is first imported, the smart scaling app calls the analysis engine for other information which it passes along to the smart scaling engine which the smart scaling app also calls. The smart scaling engine is integrated separately into the printer controller for production printing without the smart scaling app or analysis engine. In this embodiment, the smart scaling engine is embedded in the printer and reads the smart scaling file, control information (which is optionally embedded in the smart scaling file), and box dimensions+VDP replacement files to print one or more boxes of different scales and/or with different VDP elements.

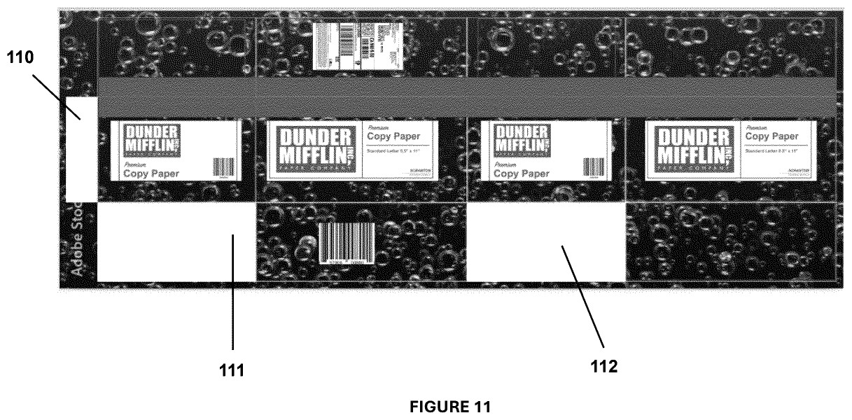

FIG. 11 shows an image of a scaled box instance that is used as a preview of the final box of FIG. 10 in which panels that should be blanked are shown. The smart scaling engine also reads configuration data from the smart scaling file or a separate application configuration file to determine which, if any, panels 110-111 should be blanked so that pigment is not printed on any flaps that are to be glued.

Other embodiments of this invention may apply selection and scaling to boxes of varying shapes and layouts, e.g. with top and/or bottom faces that are not split in half-sized flaps but are full sized with a small tab that folds into the box, removable tops, more than six faces, cylindrical, hexagonal, etc., different materials, such as non-corrugated cardboard, plastic, fiberboard, cloth, tile, or any material with a printable surface, or even non-box/non-shipping products such as building wraps or 3D printed objects. Embodiments of the invention can also be applied to printing both the inside and outside surfaces of a box or other construct.

The smart scaling app could be replaced in a different embodiment by a plugin for one or more graphics design applications, e.g. InDesign, Illustrator, QuarkXPress, etc.

Another embodiment of the invention applies the different scaling attributes to one or more whole images, for example one per panel or one per box, using Al techniques based on “inpainting” (see https://huggingface.co/docs/diffusers/using-diffusers/inpaint) and “outpainting” (see https://openai.com/blog/dall-e-introducing-outpainting) to add and remove parts of an image as needed to allow combining the different annotated areas into a single, visually pleasing image scaled to the proper box dimensions.

### Computer Implementation

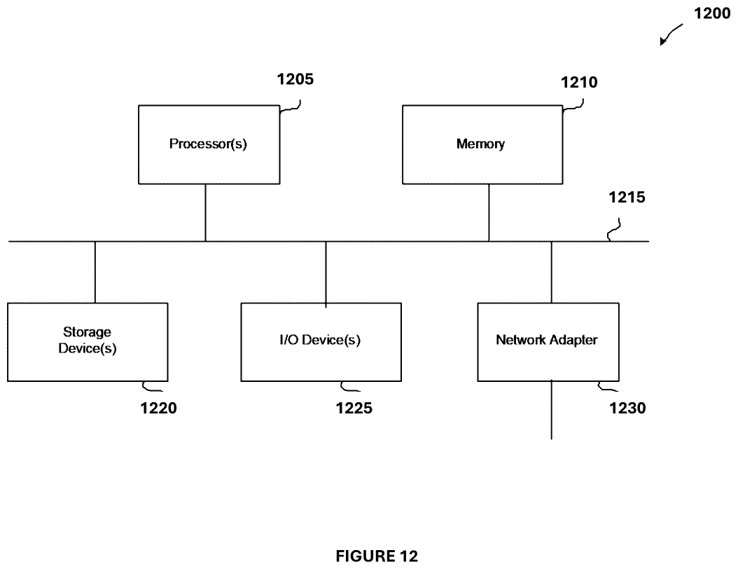

FIG. 12 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 1200 may include one or more central processing units (“processors”) 1205, memory 1210, input/output devices 1225, e.g. keyboard and pointing devices, touch devices, display devices, storage devices 1220, e.g. disk drives, and network adapters 1230, e.g. network interfaces, that are connected to an interconnect 1215. The interconnect 1215 is illustrated as an abstraction that represents any one or more separate physical buses, point to point connections, or both connected by appropriate bridges, adapters, or controllers. The interconnect 1215, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 1210 and storage devices 1220 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 1210 can be implemented as software and/or firmware to program the processor 1205 to carry out actions described above. In some embodiments, such software or firmware may be initially provided to the processing system 1200 by downloading it from a remote system through the computing system 1200, e.g. via network adapter 1230.

The various embodiments introduced herein can be implemented by, for example, programmable circuitry, e.g. one or more microprocessors, programmed with software and/or firmware, or entirely in special purpose hardwired (non-, programmable) circuitry, or in a combination of such forms. Special-purpose hardwired circuitry may be in the form of, for example, one or more ASICs, PLDs, FPGAs, etc.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A smart box scaling apparatus, comprising:
a smart scaling app configured to:
select different graphical elements in a design template for a master box design having panel and flap elements;
an analysis engine configured to:
read locations of the graphical elements of the master box design selected in the smart scaling app;
find the panels based on the design template;
identify the selected graphical elements of the master box design; and
mark the selected graphical elements with scaling attributes; and
a smart scaling engine configured to:
annotate the selected graphical elements with said scaling attributes by scaling the selected graphical elements of the master box design independently of said panels and of each other and by controlling positioning of the selected graphical elements independently of their scale; and
supply the smart scaling app with information about any graphical elements that exceed a panel/flap boundary or that overlap due to application of different scaling to the graphical elements and the panel and flap elements.

2. The apparatus of claim 1, said smart scaling engine further configured to:
maintain an aspect ratio of selected graphical elements when a panel or a flap they are on is not scaled symmetrically; and/or
maintain a size and/or a shape of selected graphical elements regardless of box size;
and/or maintain minimum offsets of selected graphical elements from a panel's or flaps side or corner to conform to marking requirements.

3. The apparatus of claim 1, wherein said scaling attributes applied to said selected graphical elements comprise any of:
symmetric (equal horizontal and vertical), asymmetric, or no scaling;
for symmetric scaling, a side that the scaling is relative to;
minimum and/or maximum width and/or height;
fixed offset from a corner or side; and/or
minimum offset from a corner or side.

4. The apparatus of claim 1, wherein said smart scaling app is further configured to:
specify graphical elements to be replaced by a specific substitute graphical element at print time with a custom color in the design template that flags said specified graphical elements for replacement.

5. The apparatus of claim 4, wherein said smart scaling engine is further configured to:
draw said specified graphical elements in the design template; and
lock said specified graphical elements in place with default scaling attributes to maintain said specified graphical elements in a same place, to scale said specified graphical elements properly for multiple promotions, and to prevent repositioning or drawing over of said specified graphical elements.

6. The apparatus of claim 1, wherein said smart scaling app is further configured to:
add graphical elements directly to the design template via annotations.

7. The apparatus of claim 1, wherein graphical elements that are not annotated with special scaling attributes are scaled with a same ratio as the sides of the panel or flap on which they are located.

8. The apparatus of claim 1, wherein said smart scaling engine is further configured to:
maintain a shape of specific selected graphical elements regardless of a relative width and height of selected panels, while other graphical elements scale differently in the vertical and horizontal directions on said selected panels.

9. The apparatus of claim 8, wherein said smart scaling engine is further configured to:
maintain text and graphics scale relative to a panels' sides on all panels, independent of scaling said selected graphical elements, wherein graphics that cross panel boundaries meet up at the panel's edges.

10. The apparatus of claim 1, wherein said smart scaling engine is further configured to:
provide a background image large enough to cover an entire surface area of a largest box size.

11. The apparatus of claim 1, wherein said smart scaling engine is further configured to:
scale a background image to fit an entire surface area of a current box size.

12. The apparatus of claim 1, wherein said smart scaling engine is further configured to:
preview a final box which shows panels that are to be blanked.

13. The apparatus of claim 1, wherein said smart scaling engine is further configured to:
apply selection and scaling to boxes having shapes and layouts comprising any of:
top and/or bottom faces that are not split in half-sized flaps but are full sized with a small tab that folds into the box;
removable tops;
boxes having more than six faces;
cylindrical boxes;
hexagonal boxes;
boxes made of different materials, including any of non-corrugated cardboard, plastic, fiberboard, cloth, tile, or any other material having a printable surface;
non-box/non-shipping products, including any of building wraps or 3D printed objects; and
boxes which are printed on both inside and outside surfaces.

14. The apparatus of claim 1, wherein said smart scaling app comprises a plugin for one or more graphics design applications.

15. The apparatus of claim 1, wherein said smart scaling engine is further configured to:
use inpainting to apply different scaling attributes to one or more whole images.

16. The apparatus of claim 1, wherein said smart scaling engine is further configured to:
use outpainting to add and/or remove parts of an image to combine different annotated areas into a single, visually pleasing image scaled to proper box dimensions.

17. The apparatus of claim 1, wherein said smart scaling engine comprises:
an embedded scaling engine within a printer that reads a smart scaling file, control information which is optionally embedded in the smart scaling file, and box dimensions+VDP replacement files to print one or more boxes of different scales and/or with different VDP elements.

18. The apparatus of claim 1, wherein said smart scaling engine is further configured to:
create multiple final box files of different dimensions and/or with different variable data for each box from a smart scaling file in a single invocation, allowing for high-speed box production.

19. The apparatus of claim 1, wherein said smart scaling engine produces a list of intersections for multiple box sizes; and
wherein said smart scaling app presents information of all available box sizes at the same time to a user to preview.

20. A method for scaling a box, comprising:
with a smart scaling app:
selecting different graphical elements in a design template for a master box design having panel and flap elements:
with an analysis engine:
reading locations of the graphical elements of the master box design selected in the smart scaling app;
finding the panels based on the design template;
identifying the selected graphical elements of the master box design; and
marking the selected graphical elements with scaling attributes; and
with a smart scaling engine:
annotating the selected graphical elements with said scaling attributes by scaling the selected graphical elements of the master box design independently of said panels and of each other and by controlling positioning of the selected graphical elements independently of their scale; and
supplying the smart scaling app with information about any graphical elements that exceed a panel/flap boundary or that overlap due to application of different scaling to the graphical elements and the panel and flap elements.

21. The method of claim 20, further comprising:
maintaining an aspect ratio of selected graphical elements when a panel or a flap they are on is not scaled symmetrically; and/or
maintaining a size and/or a shape of selected graphical elements regardless of box size; and/or
maintaining minimum offsets of selected graphical elements from a panel's side or corner to conform to marking requirements.

22. The method of claim 20, wherein said scaling attributes applied to said selected graphical elements comprise any of:
symmetric (equal horizontal and vertical), asymmetric, or no scaling;
for symmetric scaling, a side that the scaling is relative to;
minimum and/or maximum width and/or height;
fixed offset from a corner or side; and/or
minimum offset from a corner or side.

23. The method of claim 20, further comprising:
specifying graphical elements to be replaced by a specific substitute graphical element at print time with a custom color in the design template that flags said specified graphical elements for replacement.

24. The method of claim 23, further comprising:
drawing said specified graphical elements in the design template; and
locking said specified graphical elements in place with default scaling attributes to maintain said specified graphical elements in a same place, to scale said specified graphical elements properly for multiple promotions, and to prevent repositioning or drawing over of said specified graphical elements.

25. The method of claim 20, further comprising:
adding graphical elements directly to the design template via annotations.

26. The method of claim 20, further comprising:
scaling graphical elements that are not annotated with special scaling attributes with a same ratio as the sides of the panel or flap on which they are located.

27. The method of claim 20, further comprising:
maintaining a shape of selected graphical elements regardless of a relative width and height of selected panels, while other graphical elements scale differently in the vertical and horizontal directions on said selected panels.

28. The method of claim 27, further comprising:
maintaining text and graphics scale relative to a panels' sides on all panels, independent of scaling said selected graphical elements, wherein graphics that cross panel boundaries meet up at the panel's edges.

29. The method of claim 20, further comprising:
providing a background image large enough to cover an entire surface area of a largest box size.

30. The method of claim 20, further comprising:
scaling a background image to fit an entire surface area of a current box.

31. The method of claim 20, further comprising:
previewing a final box which shows panels that are to be blanked.

32. The method of claim 20, further comprising:
applying selection and scaling to boxes having shapes and layouts comprising any of:
top and/or bottom faces that are not split in half-sized flaps but are full sized with a small tab that folds into the box;
removable tops;
boxes having more than six faces;
cylindrical boxes;
hexagonal boxes;
boxes made of different materials, including any of non-corrugated cardboard, plastic, fiberboard, cloth, tile, or any other material having a printable surface;
non-box/non-shipping products, including any of building wraps or 3D printed objects; and
boxes which are printed on both inside and outside surfaces.

33. The method of claim 20, wherein said smart scaling app comprises a plugin for one or more graphics design applications.

34. The method of claim 20, further comprising:
using inpainting to apply different scaling attributes to one or more whole images.

35. The method of claim 20, further comprising:
using outpainting to add and/or remove parts of an image to combine different annotated areas into a single, visually pleasing image scaled to proper box dimensions.

36. The method of claim 20, wherein said smart scaling engine comprises:
an embedded scaling engine within a printer that reads a smart scaling file, control information which is optionally embedded in the smart scaling file, and box dimensions+VDP replacement files to print one or more boxes of different scales and/or with different VDP elements.

37. The method of claim 20, further comprising:
creating multiple final box files of different dimensions and/or with different variable data for each box from a smart scaling file in a single invocation, allowing for high-speed box production.

38. The method of claim 20, further comprising:
said smart scaling engine producing a list of intersections for multiple box sizes; and
said smart scaling app presenting a list of all available box sizes at the same time to a user to preview.
